(19) United States
(12) Patent Application Publication
(10) Pub. No.: US 2008/0105535 A1
(43) Pub. Date: May 8, 2008

(54) Composite Metal Oxide Photocatalyst Exhibiting Responsibility to Visible Light

(75) Inventors: Yoshihiro Nakato, Osaka (JP); Haimei Liu, Osaka (JP); Ryuhei Nakamura, Osaka (JP)

Correspondence Address: POSZ LAW GROUP, PLC, 12040 SOUTH LAKES DRIVE, SUITE 101, RESTON, VA, 20191, US

(73) Assignees: Osaka University, Suita-shi, OSAKA (JP); The New Industry Research Organization, Chuo-ku, Kobe-shi, HYOGO (JP)

(21) Appl. No.: 11/792,824

(22) PCT Filed: Dec. 13, 2005
(86) PCT No.: PCT/JP05/22870

§ 371 Date: Jun. 12, 2007

(30) Foreign Application Priority Data
Dec. 13, 2004 (JP) 2004-359355

(51) Int. Cl. C01G 23/04; C01B 13/02; C01G 31/02; C01G 33/00; C01G 29/00; C07B 63/00

(52) U.S. Cl. 204/157.5; 423/598; 423/594.7; 204/158.21

(57) ABSTRACT

A new photocatalyst, which is high in visible light response, is great in quantum efficiency, and is more excellent in photocatalytic activity, is provided. A composite metal oxide, prepared combining two photocatalytic systems of TiO₂ and BiVO₄, including elements of Bi, Ti, and Vi as composition elements, can be a photocatalyst having a high activity under visible light. Particularly, BiTiVO₆, which is obtained at a compounding ratio of 1:1, can be a photocatalyst having a remarkably high activity under visible light. Moreover, a composite metal oxide expressed by a general formula BiTiMO₆ (in the formula, M represents at least one element selected from a group consisting of V, Nb, and Ta) can be a photocatalyst having a high activity under visible light.

### TECHNICAL FIELD

The present invention relates to a photocatalyst made of a new compound with visible light response, and particularly, relates to a water-splitting photocatalyst capable of efficiently generating a photocurrent by photooxidization of water (oxygen evolution) or a photocatalyst capable of efficiently decomposing organic matter such as methanol under visible light.

### BACKGROUND ART

In recent years, photocatalysts using metal oxides such as TiO₂ have been actively studied and technologized. In addition, as an application example of a photocatalyst such as TiO₂, a method for producing hydrogen by photodecomposition of water by use of a photocatalyst has been known.

However, since all the photocatalysts such as TiO₂ have a large bandgap of 3 eV or more, these respond to only an ultraviolet light with a wavelength of 400 nm or less contained in sunlight in only a small quantity, so that there is a problem that efficiency is low for general use on the ground. In addition, since holes and electrons generated by absorbing light with a wavelength having energy equal to or greater than the bandgap have charges opposite to each other and thus easily cause recombination, there is also a problem that photocatalytic activity does not last.

In order to overcome such problems, recently, a photocatalyst with visible light response has been actively studied, and some reports have been made. For example, it has been reported to improve a manufacturing method for a fine powder of bismuth vanadate (BiVO₄) so as to enhance visible light response (Patent Document 1, Patent Document 2). In addition, it has been studied to enhance the sensitivity of visible light response by doping transition elements such as nitride, carbon, sulfur, and chromium into TiO₂ and the like.

### [Patent Document 1] Japanese Published Unexamined Patent Application No. 2004-24936

### [Patent Document 2] Japanese Published Unexamined Patent Application No. 2001-2419

### DISCLOSURE OF THE INVENTION

### [Problem to be Solved by the Invention]

The present invention has been made in view of insufficiency in photocatalytic activity with visible light response in the background art, and an object thereof is to provide a highly-active photocatalyst capable of exhibiting a photocatalytic function even by sunlight with efficiency, that is, a photocatalyst whose photocatalytic activity never disappears even when formed in a microparticle membrane or suspended in water, for example, a photocatalyst suitably used for photodecomposition of water. By preparing a photocatalyst with visible light response higher in activity than titanium dioxide (TiO₂) and bismuth vanadate (BiVO₄) being known photocatalysts, the present invention aims to extend the field of application to antifouling, deodorizing, and antibacterializing purposes for indoors and car interiors by use of visible light such as sunlight and fluorescent light.

### [Means for Solving the Problem]

As a result of keen study on a highly efficient sunlight water-splitting system by interfacial nano-control, the present inventors have discovered that a composite metal oxide expressed by a composition formula BiTiVO₆ exhibits a high response to visible light and have thereby succeeded in preparing a highly-active photocatalyst enabling water splitting even by sunlight.

In a first aspect of the present invention, a composite metal oxide, prepared by combination of two photocatalytic systems of TiO₂ and BiVO₄, including elements of Bi, Ti, and V as composition elements, can be a photocatalyst having a high activity under visible light. Here, the two photocatalytic systems of TiO₂ and BiVO₄ can be compounded at a free ratio of 1:9 to 9:1 in molar ratio, and the composite metal oxide including elements of Bi, Ti, and V as composition elements can be a photocatalyst having a high activity under visible light. In particular, BiTiVO₆ obtained by providing a compounding ratio at 1:1 is preferable as a photocatalyst having a remarkably high activity under visible light. That is, although the compounding ratio of the two photocatalytic systems of TiO₂ and BiVO₄ can be freely changed, the ratio of 1:1 in molar ratio is preferable for a photocatalyst having a high activity.

The reason that the two photocatalytic systems of TiO₂ and BiVO₄ can be compounded at a free ratio of 1:9 to 9:1 in molar ratio, and the composite metal oxide including elements of Bi, Ti, and V as composition elements can be a photocatalyst having a high activity under visible light is because it is recognized that an XRD pattern of BiVO₄ and BiTiVO₆ of the present invention shown in FIG. 18 and an XRD pattern of TiO₂ and BiTiVO₆ of the present invention show almost identical peaks, and it can be considered based on this that the composite metal oxide has a structure where Ti4+(0.605 Å) are V5+(0.59 Å) for each other. Therefore, it is considered the composite metal oxide can be a photocatalyst even when the two photocatalytic systems of TiO₂ and BiVO₄ are compounded at a considerably free ratio. However, BiTiVO₆ obtained by providing the compounding ratio at 1:1 is considered to be a photocatalyst having the highest activity under visible light. In this connection, FTO means fluorine-doped tin oxide.

In embodiments to be described below as well, it is shown that a photocatalyst having the highest activity under visible light can be obtained even when the two photocatalytic systems of TiO₂ and BiVO₄ are provided at 1:4 or 4:1 in molar ratio.

In a second aspect of the present invention, a composite metal oxide, expressed by a general formula BiTiMO₆ (in the formula, M represents at least one element selected from a group consisting of V, Nb, and Ta) can be a photocatalyst having a high activity under visible light. In particular, BiTiVO₆where M is V can be a photocatalyst having a remarkably high activity under visible light.

Here, the composite metal oxide expressed by a general formula BiTiMO₆ (in the formula, M represents at least one element selected from a group consisting of V, Nb, and Ta) is prepared by firing a powder mixture of one selected from NH₄VO₃, Nb₂O₅, and Ta₂O₅ and Bi₂O₃ and TiO₂ under predetermined time and temperature conditions (first firing step), then once cooling, crushing, and again firing the fired product under conditions of the predetermined time and a higher temperature than that of the first firing step (second firing step), and then gradually cooling the fired product.

Here, it is preferable that the above-described first firing step and the second firing step are carried out under high humidity. Carrying out under high humidity means, for example, placing water in a reaction vessel.

Moreover, it is preferable that the above-described first firing step is carried out under a temperature condition of 550 to 750° C. and the second firing step is carried out under a temperature condition of 800 to 900° C. Although concrete manufacturing conditions are shown in embodiments to be described later, it is further preferable that the first firing step is carried out at 700° C. for 30 hours and the second firing step is carried out at 850° C. for 30 hours.

Moreover, it is more preferable that the composite metal oxide obtained by the aforementioned manufacturing method is further applied with an etching treatment in hydrochloric acid or sulfuric acid. Thereby, the particle form and size of the composite metal oxide are changed, the specific surface area per unit gram is increased, and activity is improved.

Moreover, it is more preferable that the composite metal oxide obtained by the aforementioned manufacturing method is further crushed by a ball mill. The specific surface area per unit gram is increased, and activity is improved.

In a third aspect of the present invention, a composite metal oxide, prepared by combination of any metal oxide of Cao, NiO, and ZnO and a photocatalytic system of BiVO₄, including elements of Bi, L (L=Ca, Ni, Zn), and V as composition elements, can be a photocatalyst having a high activity under visible light.

In a fourth aspect of the present invention, a composite metal oxide, expressed by a general formula BiL₂VO₆ (in the formula, L represents at least one element selected from a group consisting of Ca, Ni, and Zn) can be a photocatalyst having a high activity under visible light.

Here, the composite metal oxide expressed by a general formula BiL₂VO₆ (in the formula, L represents at least one element selected from a group consisting of Ca, Ni, and Zn) is prepared by firing a powder mixture of a metal oxide selected from CaO, NiO, and ZnO and Bi₂O₃ and TiO₂ under predetermined time and temperature conditions (first firing step), then once cooling, crushing, and again firing the fired product under conditions of the predetermined time and a higher temperature than that of the first firing step (second firing step), and then gradually cooling the fired product.

Here, it is preferable that the above-described first firing step and the second firing step are carried out under high humidity. Carrying out under high humidity means, for example, placing water in a reaction vessel.

Moreover, it is preferable that the above-described first firing step is carried out under a temperature condition of 550 to 750° C. and the second firing step is carried out under a temperature condition of 800 to 900° C. Although concrete manufacturing conditions are shown in embodiments to be described later, it is further preferable that the first firing step is carried out at 700° C. for 30 hours and the second firing step is carried out at 850° C. for 30 hours.

Moreover, it is more preferable that the composite metal oxide obtained by the aforementioned manufacturing method is further applied with an etching treatment in hydrochloric acid or sulfuric acid. Thereby, the particle form and size of the composite metal oxide are changed, the specific surface area per unit gram is increased, and activity is improved.

Moreover, in a fifth aspect of the present invention, the present invention can be used as a photocatalyst by using the composite metal oxide according to the first to fourth aspects of the present invention in a microparticle membrane form.

Moreover, in a sixth aspect of the present invention, the present invention can be used as a photocatalyst by using the composite metal oxide according to the first to fourth aspects of the present invention in a suspension form.

Moreover, in a seventh aspect of the present invention, the present invention can be utilized as a method for producing oxygen and/or hydrogen by photodecomposition of water under irradiation of light including at least visible light by use of the photocatalyst according to any one of the first to sixth aspects of the present invention.

Moreover, in an eighth aspect of the present invention, the present invention can be utilized as a purifying method by photodecomposition of organic matter (such as methanol) under irradiation of light including at least visible light by use of the photocatalyst according to any one of the first to sixth aspects of the present invention.

Moreover, in a ninth aspect of the present invention, the present invention can be applied to a wide variety of application fields of a photocatalyst (antifouling self-cleaning, antibacterializing, and antifogging field, air purification, water purification, and the like) by providing on a surface of a base material a coating of the photocatalyst according to any of the first to fourth aspects of the present invention.

Moreover, in a tenth aspect of the present invention, the present invention can be used as an article useful as a photocatalyst, an optical sensor, a photocell material, an optical antifouling material, an optical hydrophilic material, an optical antibacterial material, or the like by a visible-light responsive paint including as a material the photocatalyst according to any of the first to fourth aspects of the present invention.

### [Effects of the Invention]

Photocatalysts have already been commercialized and put on the market, however, most of the photocatalysts use TiO₂ and allow only use of ultraviolet light so far, so that practical activity is low. The new composite metal oxide according to the present invention has a high sensitivity to visible light and therefore provides an effect such that activity is greatly improved, the amount of the photocatalyst can be reduced for conventional purposes, and applications can be greatly expanded since applications can be extended to regions for which the photocatalyst has not conventionally been able to be used due to insufficiency in activity.

In particular, the photocatalyst of new BiTiVO₆ microparticles is a photocatalyst with a high visible light response capable of improving sunlight utilization efficiency and has high practicability.

Moreover, the photocatalyst of the present invention has both high oxidization capacity and reduction capacity to other substances and therefore has an effect such that this can be applied not only to a water-splitting reaction but also to, for example, environmental cleanup such as an organic-matter decomposing reaction, a metal-ion reduction reaction, or a nitride oxide treatment, so that endocrine disrupting chemicals existing in a to-be-purified system, in particular, a to-be-purified water system can be photodecomposed.

### BRIEF DESCRIPTION OF THE DRAWINGS

FIG. 1 shows a diffuse reflectance spectrum of a photocatalyst BiTiVO₆ according to the present invention.

FIG. 2 shows an absorption spectrum diagram, determined by the diffuse reflectance spectrum of a photocatalyst BiTiVO₆ according to the present invention, whose horizontal axis has been scale-changed to photoenergy from a wavelength.

FIG. 3 shows diffuse reflectance spectra of photocatalysts BiTiVO₆, BiTiNbO₆, and BiTiTaO₆ according to the present invention.

FIG. 4 shows an absorption spectrum diagram, determined by the diffuse reflectance spectra of photocatalysts BiTiVO₆, BiTiNbO₆, and BiTiTaO₆ according to the present invention, whose horizontal axis has been scale-changed to photoenergy from a wavelength.

FIG. 5 shows a diffuse reflectance spectrum of a photocatalyst BiTiVO₆ according to the present invention in comparison with photocatalysts BiVO₄ and TiO₂.

FIG. 6 shows characteristics of oxygen evolution from an NaIO₃ aqueous solution by a visible light irradiation to a photocatalyst BiTiVO₆ powder according to the present invention in comparison with photocatalysts BiVO₄ and W0₃.

FIG. 7 shows action spectra of photocurrent quantum yields (IPCEs) at various potentials of a photocatalyst BiTiVO₆ microparticle membrane according to the present invention.

FIG. 8 shows action spectra of photocurrent quantum yields (IPCEs) (at a potential 1.0V) in a comparison between photocatalyst BiTiVO₆ microparticle membrane and photocatalyst BiVO₄ microparticle membrane electrodes according to the present invention.

FIG. 9 shows a surface SEM photograph of photocatalyst BiTiVO₆ microparticles according to the present invention.

FIG. 10 shows XPS spectra (regions of Bi4f, Ti2p, V2p, and O1s) of photocatalyst BiTiVO₆ microparticles according to the present invention.

FIG. 11 shows photocurrent-potential curves of a photocatalyst BiTiVO₆ microparticle membrane electrode according to the present invention.

FIG. 12 shows photocurrent-potential curves of a photocatalyst BiVO₄ microparticle membrane electrode under pseudo sunlight irradiation.

FIG. 13 shows an action spectrum of photocurrent quantum yields (IPCEs) (at a potential 1.0V) of a photocatalyst BiTiVO₆ according to the present invention in the presence of methanol.

FIG. 14 shows a diffuse reflectance spectrum of a photocatalyst BiZn₂VO₆ according to the present invention.

FIG. 15 shows action spectra of photocurrent quantum yields (IPCEs) of a photocatalyst BiZn₂VO₆ microparticle membrane according to the present invention in a comparison between the presence and absence of methanol (at a potential 1.0V on an Ag/AgCl reference electrode basis.)

FIG. 16 shows oxygen evolution characteristics by a visible light irradiation to a photocatalyst BiZn₂VO₆ powder.

FIG. 17 shows SEM photographs of a photocatalyst BiZn₂VO₆ powder.

FIG. 18 is an XRD pattern of a photocatalyst BiTiVO₆ (on an FTO.)

FIG. 19 shows diffuse reflectance spectra when two photocatalytic systems of TiO₂ and BiVO₄ are compounded at molar ratios of 1:4 and 1:2.

FIG. 20 shows photocurrent-potential curves of a membrane electrode when two photocatalytic systems of TiO₂ and BiVO₄ are compounded at a molar ratio of 1:2.

FIG. 21 shows diffuse reflectance spectra when two photocatalytic systems of TiO₂ and BiVO₄ are compounded at molar ratios of 4:1 and 2:1.

FIG. 22 shows photocurrent-potential curves of a membrane electrode when two photocatalytic systems of TiO₂ and BiVO₄ are compounded at a molar ratio of 2:1.

### BEST MODE FOR CARRYING OUT THE INVENTION

Hereinafter, preferred embodiments of a photocatalyst of the present invention will be described in detail while raising an example of application to composition, a manufacturing method, water splitting, or organic-matter decomposition. However, these embodiments of the invention will be described for better understanding of the gist of the invention, and do not limit the contents of the invention unless particularly designated.

A manufacturing method for a photocatalyst according to the present invention is not particularly limited, and the photocatalyst can be manufactured by means of a known method, for example, a solid-phase process, a wet process, or a gas-phase process, and here, a manufacturing method by a solid-phase process will be described in the following.

In the manufacturing method by a solid-phase process for a microparticle membrane of a new photocatalyst BiTiVO₆ being an embodiment of the present invention, the temperature and time are important conditions.

First, respective metal composite oxides and the like to be raw materials are mixed at a predetermined compounding ratio, and are fired, for example, in the atmosphere, at a firing temperature of 700° C. for 30 hours. Next, the fired product is cooled to a room temperature, finely crushed, and then again fired at 850° C. for 30 hours. Thereby, the objective photocatalyst can be manufactured.

When composite metal oxide microparticles of the obtained photocatalyst BiTiVO₆ are irradiated with light in a form of a suspension or a membrane, excited electrons and holes are generated within the microparticles, and these cause a reduction reaction and an oxidation reaction, respectively, on the surface of the microparticles.

Since the photocatalyst BiTiVO₆ according to the present invention has both high oxidization capacity and reduction capacity to other substances, this can be applied not only to a water-splitting reaction but also to, for example, environmental cleanup such as an organic-matter decomposition reaction, a metal-ion reduction reaction, or a nitride oxide treatment.

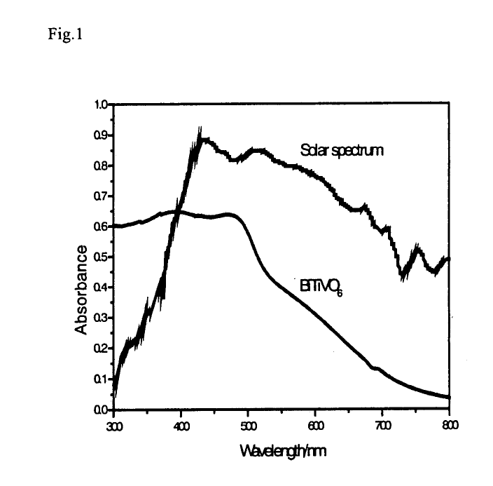

In FIG. 1, shown is a diffuse reflectance spectrum of a photocatalyst BiTiVO₆ being an embodiment of the present invention. In addition, as a reference, wavelength dependence of sunlight energy density (solar spectrum) is plotted. Of the illustrated solar spectrum, a section with a wavelength of 400 nm or less, a section with a wavelength of 400 nm to 750 nm, and a section with a wavelength of 750 nm or more are divided into regions of ultraviolet light, visible light, and infrared light, respectively, it can be understood with regard to the photocatalyst BiTiVO₆ according to the present invention that the diffuse reflectance spectrum is extended broadly across the visible light region. In the case of a titanium dioxide (TiO₂) photocatalyst having characteristics responding to ultraviolet rays but not responding to visible rays, it can be understood that for a diffuse reflectance spectrum thereof, no absorption is observed at 400 nm or more, while for the photocatalyst BiTiVO₆ according to the present invention, absorption is observed from 400 nm or more to around 800 nm.

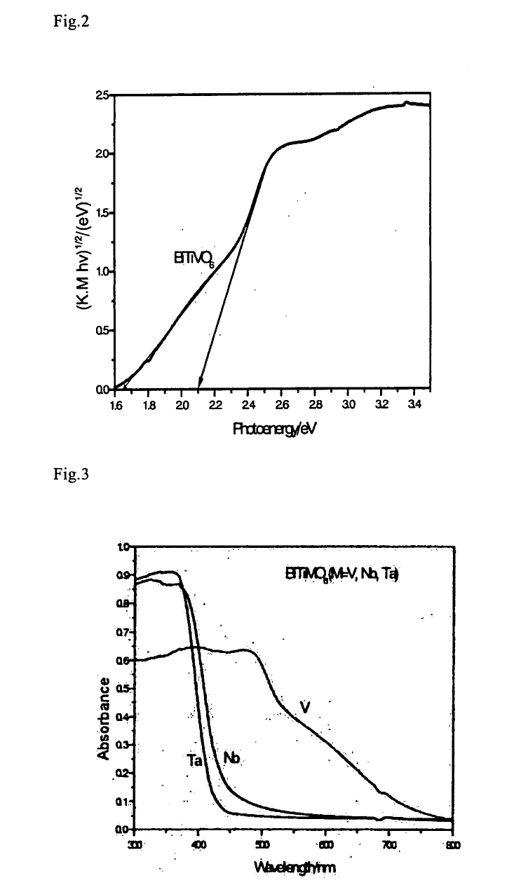

In FIG. 2, shown is an absorption spectrum diagram, determined by the diffuse reflectance spectrum of a photocatalyst BiTiVO₆ according to the present invention, whose horizontal axis has been scale-changed to photoenergy from a wavelength. It can be understood from FIG. 2 that the photocatalyst BiTiVO₆ according to the present invention has a narrow bandgap of 2.1 eV, and absorbs light in the visible light region.

Hereinafter, the present invention will be described in detail based on embodiments, however, the present invention is not interpreted in a limited manner by this exemplification. Devices used for observing composition and form and measuring characteristics of the obtained photocatalyst will be described in the following.

The composition of a sample was identified by use of an XPS (ESCA 2000, manufactured by SHIMADZU CORPORATION). In addition, a crystal form was determined by an XRD (manufactured by Phillips, Model: X′ Pert Diffractometer), a particulate form was observed by a scanning electron microscope (SEM) (manufactured by Hitachi, Model: S-5000), and a diffuse reflectance spectrum was measured by an ultraviolet visible and near-infrared spectrophotometer (manufactured by JASCO, Model: V-570). In addition, for an oxygen evolving light source, a combination of a filter (L42 cutoff filter) that cuts off light with a wavelength of 420 nm or less and a 300 W Xe lamp was used. In addition, for a light source that decomposes organic matter, a combination of a filter (L42 cutoff filter) that cuts off light with a wavelength of 420 nm or less and a 300 W Xe lamp was used for a measurement.

### EMBODIMENT 1

### (Manufacturing Methods for Microparticles of Photocatalysts BiTiVO₆, BiTiNbO₆, and BiTiTaO₆)

First, a manufacturing method for photocatalyst BiTiVO₆ microparticles according to the present invention will be described. As reactants, Bi₂O₃ (99.99%, manufactured by Wako), TiO₂ (ST-01) and NH₄VO₃ (99.0%, manufactured by Wako) are used, and appropriate amounts of these are mixed in a powder form. Next, the mixed reactants are first-fired, for example, in the atmosphere, at a firing temperature of 700° C. for 30 hours. Then, the fired product is cooled to a room temperature, finely crushed, and then again second-fired at 850° C. for 30 hours. Then, by slow cooling, the objective photocatalyst can be manufactured. A dark yellow powder is obtained.

Similarly, microparticles of photocatalysts BiTiNbO₆ and BiTiTaO₆ according to the present invention are manufactured as follows. That is, in the above-described manufacturing method for the photocatalyst BiTiTaO₆, mixed reactions respectively using Nb₂O₅ and Ta₂O₅ in place of NH₄VO₃ are first-fired at a firing temperature of 850° C. for 30 hours. Then, the fired product is cooled to a room temperature, finely crushed, and then again fired at 1000° C. for 12 hours.

Moreover, in the manufacturing process of the photocatalysts BiTiVO₆, BiTiNbO₆, and BiTiTaO₆ prepared by the above-described method, by causing a sintering reaction under a condition of high humidity by placing water in a reaction vessel, for example, it becomes possible to further improve the activity of the photocatalysts.

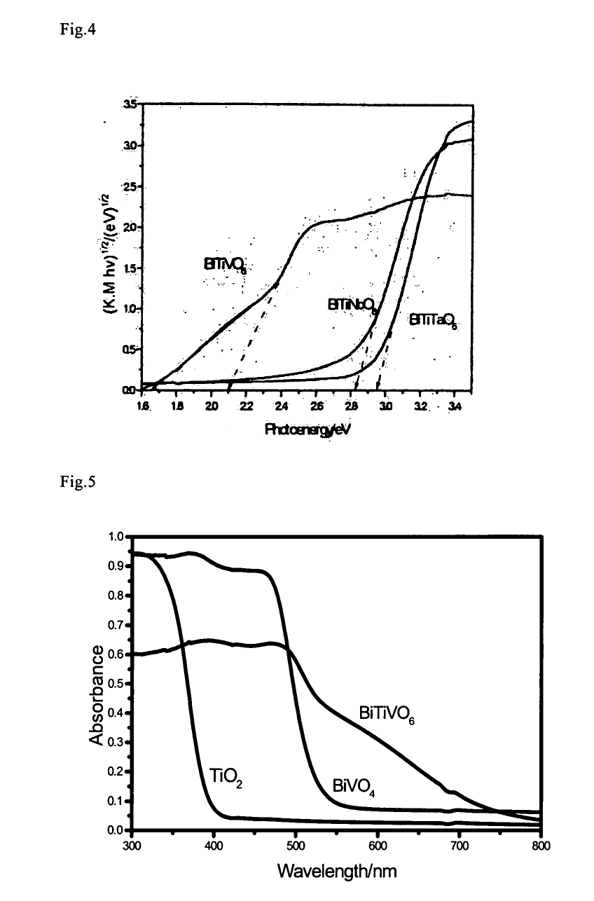

FIG. 3 shows diffuse reflectance spectra of photocatalysts BiTiVO₆, BiTiNbO₆, and BiTiTaO₆ according to the present invention. In addition, FIG. 4 shows an absorption spectrum diagram, determined by the diffuse reflectance spectra of photocatalysts BiTiVO₆, BiTiNbO₆, and BiTiTaO₆ according to the present invention, whose horizontal axis has been scale-changed to photoenergy from a wavelength.

Moreover, in the following table 1, shown are original materials according to a manufacturing method for photocatalysts BiTiVO₆, BiTiNbO₆, and BiTiTaO₆, colors of photocatalyst powders being obtained products, and bandgaps obtained by FIG. 3 and FIG. 4.

TABLE 1

| | Original | | |
|---|---|---|---|
| BiTiMO₆ | materials | Band Gap | Color |
| BiTiVO₆ | Bi₂O₃, | 2.1 eV | Dark yellow |
| | TiO₂, NH₄VO₃ | | |
| BiTiNbO₆ | Bi₂O₃, TiO₂, | 2.8 eV | White |
| | Nb₂O₅ | | |
| BiTiTaO₆ | Bi₂O₃, TiO₂, | 2.95 eV | White |
| | Ta₂O₅ | | |

FIG. 5 shows a diffuse reflectance spectrum of a photocatalyst BiTiVO₆ according to the present invention in comparison with bismuth vanadate (BiVO₄) and titanium dioxide (TiO₂) being known photocatalysts with visible light response. It can be understood from FIG. 5 that bismuth vanadate (BiVO₄) being a known photocatalyst with visible light response absorbs light with a wavelength up to 550 nm or less, while the photocatalyst BiTiVO₆ according to the present invention can absorb light with a wavelength up to 700 nm or less, and is therefore excellent in visible light response. However, currently, the photocatalyst TiO₂ in practical use absorbs ultraviolet light with a wavelength up to 400 nm or less, and this indicates that, in comparison with the existing photocatalyst, the photocatalyst according to the present invention is a potential photocatalyst that can absorb light up to the visible light region and can convert solar energy with efficiency.

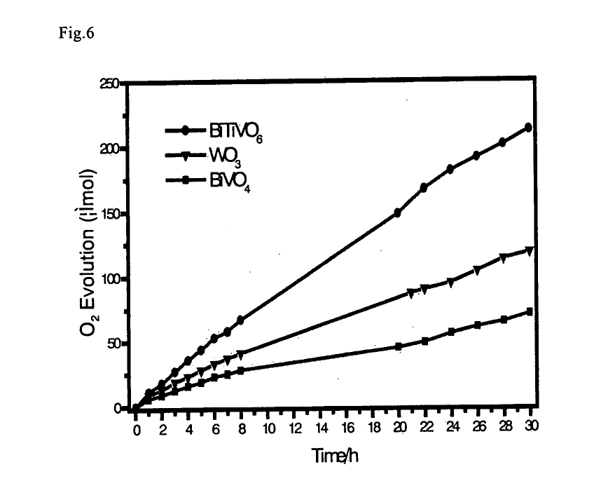

FIG. 6 shows characteristics of oxygen evolution from an NaIO₃ aqueous solution by a visible light irradiation to a photocatalyst BiTiVO₆ powder according to the present invention in comparison with known photocatalysts BiVO₄ and WO₃. The oxygen evolution reaction using various photocatalysts of FIG. 6 was carried out within a closed circulation system. For the catalysts, a BiTiVO₆ (1 to 2 μm) powder, a BiVO₄ (0.1 to 0.2 μm) powder, and a commercially available WO₃ (0.2 to 0.3 μm) powder were used. Fifty milligrams of the catalyst was mixed in an NaIO₃ aqueous solution (0.01 mol/L, 50 mL) to prepare a suspension, and a visible light (>420 nm) was irradiated thereon. As a pH control agent, a buffer La₂O₃ (50 mn) was used. For a light source, used was a 300 W Xe lamp provided with a filter (L42) that cuts off light with a wavelength of 420 nm or less. The quantity of evolved oxygen was determined by use of gas chromatography (Shimadzu, GC-148).

Judging from FIG. 6, in comparison with the known BiVO₄ and WO₃, the photocatalyst BiTiVO₆ powder according to the present invention has a steep graph gradient. That is, since an oxygen gas production (reaction speed) per unit time is greater, it can be understood that this photocatalyst has a higher oxygen evolution activity.

### EMBODIMENT 2

### (Water Splitting)

As described above, it has been suggested that the photocatalyst of the present invention can be utilized as a method for producing oxygen and/or hydrogen by photodecomposition of water under irradiation of water including at least visible light, and this will be described while showing concrete data in the following.

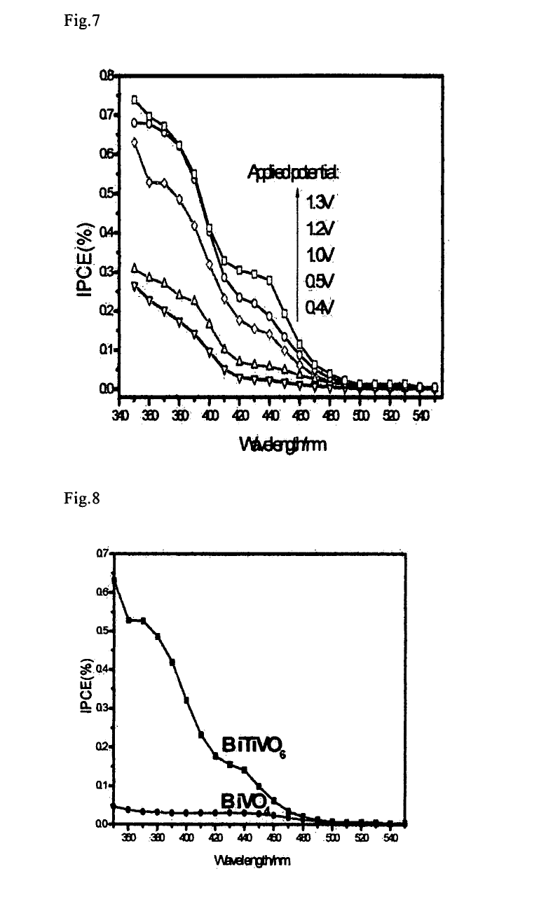

FIG. 7 shows action spectra of photocurrent quantum yields (IPCEs) of a photocatalyst BiTiVO₆ microparticle membrane according to the present invention.

Here, as measurement conditions, in a solution of an electrolyte Na₂SO₄ (0.5M), a potential (0.4V, 0.5V, 1.0V, 1.2V, 1.3V) is applied to a BiTiVO₆ membrane electrode on an Ag/AgCl reference electrode basis. FIG. 7 shows wavelength dependence of photocurrent quantum yields of the BiTiVO₆ membrane electrode, and it can be understood that a photocurrent due to oxidative decomposition of water rises from a wavelength of irradiating light of 500 nm, and oxidative decomposition of water occurs in response to a visible light irradiation up to around 500 nm.

In addition, FIG. 8 shows action spectra of photocurrent quantum yields (IPCEs) (at a potential 1.0V) in a comparison between photocatalyst BiTiVO₆ microparticle membrane and photocatalyst BiVO₄ microparticle membrane electrodes according to the present invention. It can be understood from FIG. 8 that, in comparison with the known photocatalyst BiVO₄ microparticle membrane electrode, the photocatalyst BiTiVO₆ microparticle membrane electrode according to the present invention has a remarkably high photoactivity in response to a visible light irradiation up to around 500 nm and in an oxidative decomposition reaction of water. It can be said that this expresses the results of FIG. 6 from another aspect, and conclusively proves the results of FIG. 6.

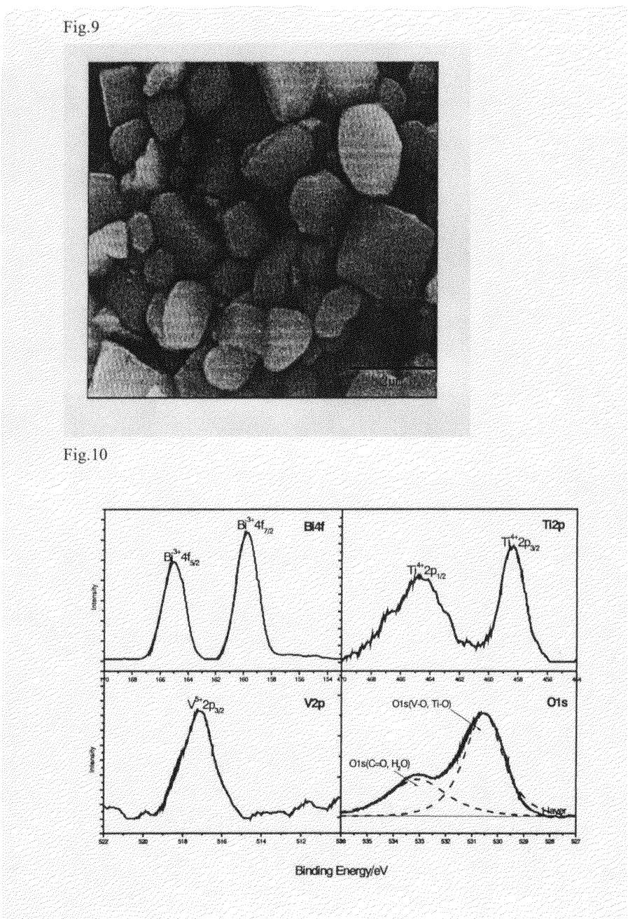

FIG. 9 shows a surface SEM photograph of photocatalyst BiTiVO₆ microparticles according to the present invention. It can be recognized from this SEM photograph that the BiTiVO₆ powder is microparticles with an average particle diameter of 1 to 2 μm having a high crystallinity.

The already-known typical photocatalyst TiO₂ has a particle size of 20 to 40 nm and BiVO₄ has a particle size of 100 to 200 nm, while the photocatalyst BiTiVO₆ of the present invention has a particle size of 1000 to 2000 nm, which is large. Since photocatalyst activity is proportional to the surface area of the particles, by further reducing the particle size, it can be expected to further improve activity of the photocatalyst BiTiVO₆ of the present invention.

FIG. 10 shows XPS spectra (in regions of Bi4f, Ti2p, V2p, and O1s) of photocatalyst BiTiVO₆ microparticles according to the present invention. It can be recognized from this that metal ions in the microparticles exist in valences of Bi³⁺, Ti⁴⁺, and V⁵⁺, and have a surface composition of BiTiVO₆ based on peak areas and sensitivity factors of the respective ions.

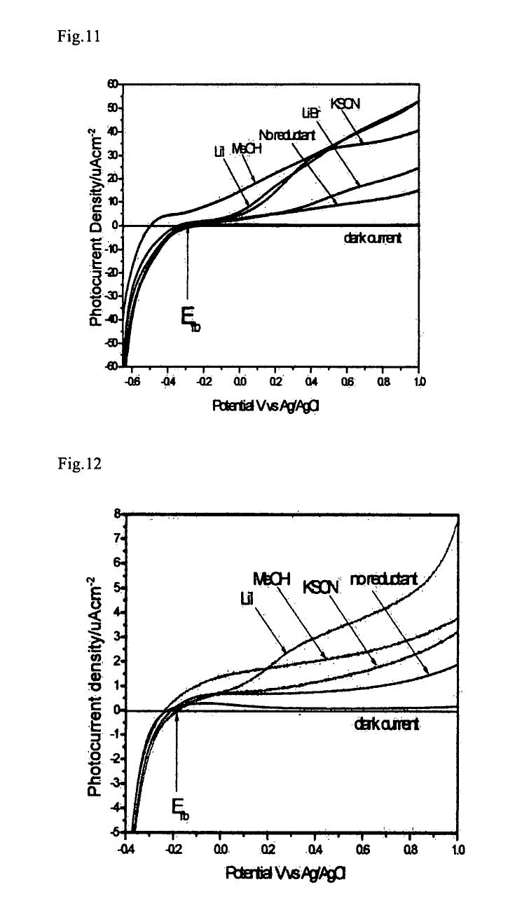

FIG. 11 shows photocurrent-potential curves of a photocatalyst BiTiVO₆ microparticle membrane electrode according to the present invention. In addition, FIG. 12 shows photocurrent-potential curves of a photocatalyst BiVO₄ microparticle membrane electrode by way of comparison. For each, a reductant (I-, MeOH, SCN-, Br-) was added to an electrolyte solution (0.5M Na₂SO₄), and photocurrent was measured under pseudo sunlight (AM1.5 G, 100 mW/cm²) irradiation.

As can be understood from FIGS. 11 and 12, thephotocatalyst BiTiVO₆ microparticle membrane electrode according to the present invention is about 10 times as great as the existing BiVO₄ in photocurrent under pseudo sunlight irradiation in terms of all reductants, and the oxidation photocurrent starts to flow from a further negative potential. Based on this, it has been confirmed that the BiTiVO₆ microparticle membrane electrode according to the present invention has a remarkably higher activity to photooxidative decomposition of various substances existing in the solution than the existing BiVO₄.

### EMBODIMENT 3

### (Organic-matter Decomposition)

As described above, since the photocatalyst of the present invention has both high oxidization capacity and reduction capacity to other substances, this can be applied not only to a water-splitting reaction but also to environmental cleanup such as an organic-matter decomposition reaction, a metal-ion reduction reaction, or a nitride oxide treatment, so that endocrine disrupting chemicals existing in a to-be-purified system, particularly, a to-be-purified water system can be photodecomposed.

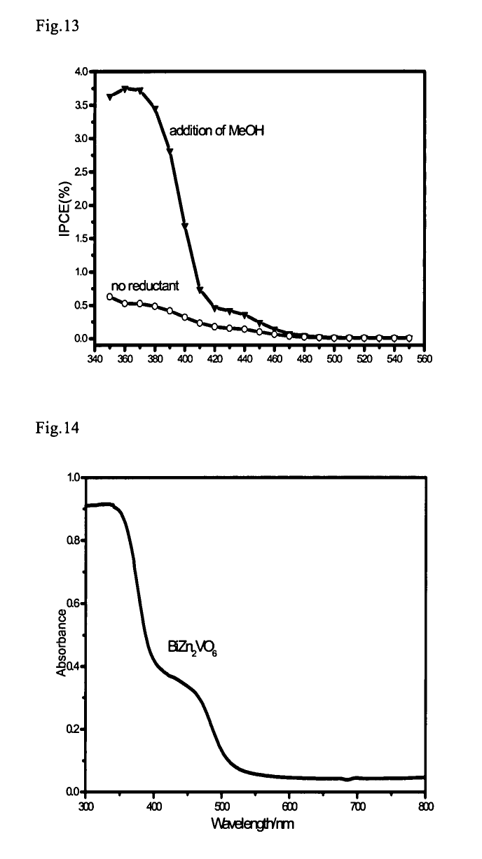

Hereinafter, a methanol decomposition reaction will be described as an organic-matter decomposition reaction while showing concrete data. In FIG. 13, shown is an action spectrum of photocurrent quantum yields (IPCEs) of a photocatalyst BiTiVO₆ microparticle membrane according to the present invention in the presence of methanol in comparison with that in the absence of methanol. As a result of adding methanol, a significant increase in photooxidation current has been confirmed in response to a visible light irradiation up to approximately 500 nm. This indicates that the BiTiVO₆ microparicles exhibit a high activity not only to oxidation of water but also to photooxidative decomposition of organic matter such as methanol under visible light irradiation.

### EMBODIMENT 4

### (Photodecomposition of Water and Methanol by BiZn₂VO₆)

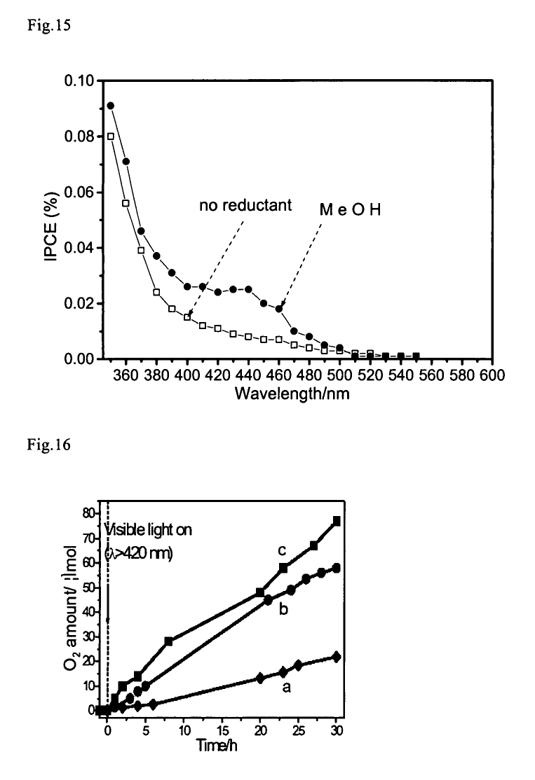

Although embodiments of the BiTiVO₆ photocatalyst have been given so far, next, an example of decomposition of water and methanol by a photocatalyst BiZn₂VO₆ according to the present invention prepared by a combination of ZnO and BiVO₄ is given. Here, for BiZn₂VO6, as reactants, Bi₂O₃ (99.99%, manufactured bywako), ZnO (99.9%, manufactured by waco), and NH₄VO₃ (99.0%, manufactured by Wako) are used, and these are first-fired, for example, in the atmosphere, at a firing temperature of 700° C. for 30 hours. Then, the fired product is cooled to a room temperature, finely crushed, and then again second-fired at 850° C. for 30 hours. Then, by slow cooling, the objective photocatalyst can be manufactured. A diffuse reflectance spectrum of this powder is shown in FIG. 14. It can be recognized that BiZn₂VO₆ according to the present invention has a strong absorption in the visible light region up to approximately 530 nm. FIG. 15 shows an action spectrum of photocurrent quantum yields (IPCEs) of a photocatalyst BiZn₂VO₆ microparticle membrane according to the present invention in a solution of an electrolyte Na₂SO₄ (0.5M). Even when no methanol existed in the solution (with no reductant), photocurrent was observed in the visible light region up to approximately 530 nm. It can be recognized from this that this photocatalyst has an ability to photooxidatively decompose water to evolve oxygen under visible light irradiation. Furthermore, as a result of the presence of methanol in the solution, a significant increase in photooxidation current has been confirmed in response to a visible light irradiation up to approximately 530 nm. This indicates that the BiZn₂VO₆ microparticles exhibit a high activity not only to photooxidative decomposition of water but also to photooxidative decomposition of organic matter such as methanol under visible light irradiation.

### EMBODIMENT 5

In the present Embodiment 5, a method for further improving activity will be described while raising an example of the photocatalyst BiZn₂VO₆ prepared in Embodiment 4. The photocatalyst BiZn₂VO₆ is prepared, as described above, by using, as reactants, Bi₂O₃ (99.99%, manufactured by Wako), ZnO (99.9%, manufactured by Wako), and NH₄VO₃ (99.0%, manufactured by Wako), mixing appropriate amounts of these powders, and firing, for example, in the atmosphere, at a firing temperature of 800° C. for 30 hours, and by carrying out an etching treatment for the obtained powder in H₂SO₄ (0.5M), activity can further be improved.

FIG. 16 shows oxygen evolution characteristics by a visible light irradiation to a photocatalyst BiZn₂VO₆ powder. In the graph of FIG. 16, a shows oxygen evolution of the photocatalyst BiZn₂VO₆ powder applied with no etching treatment in H₂SO₄ (0.5M), b shows oxygen evolution of the photocatalyst BiZn₂VO₆ powder applied with an etching treatment for 24 hours in H₂SO₄ (0.5M), and c shows oxygen evolution of the photocatalyst BiZn₂VO₆ powder applied with an etching treatment for 48 hours in H₂SO₄ (0.5M).

In greater detail, the etching treatment was carried out at 70° C. for 24 hours or 48 hours by placing 1.0 g of the BiZn₂VO₆ powder in 50 ml (0.5M) of H₂SO₄. Then, after washing, the etched BiZn₂VO₆ powder was applied with an annealing treatment at 300° C.

It is shown in FIG. 16 that, in comparison with the powder (a) applied with no etching treatment, the powder (b) applied with an etching treatment has been improved in the oxygen evolution characteristics by approximately 2.7 times, and the powder (b) applied with an etching treatment has been improved in the oxygen evolution characteristics by approximately 3.5 times.

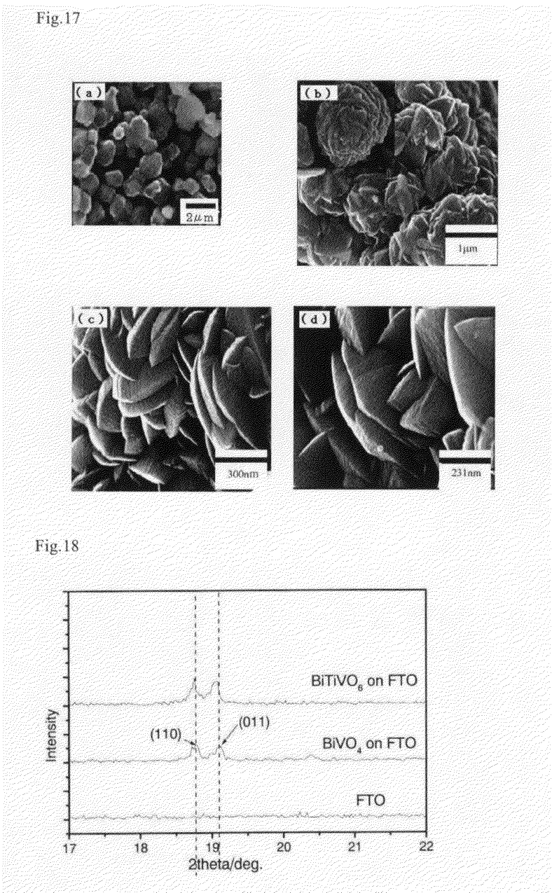

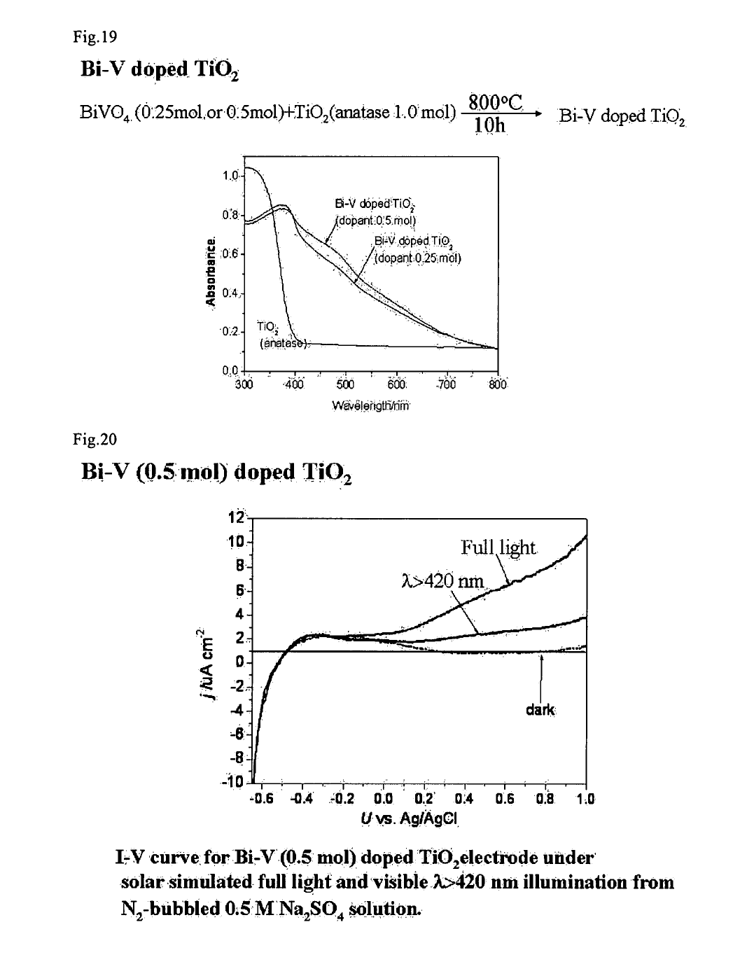

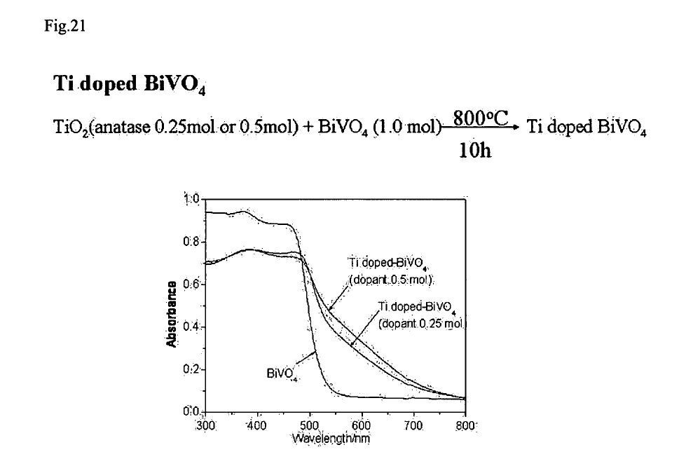

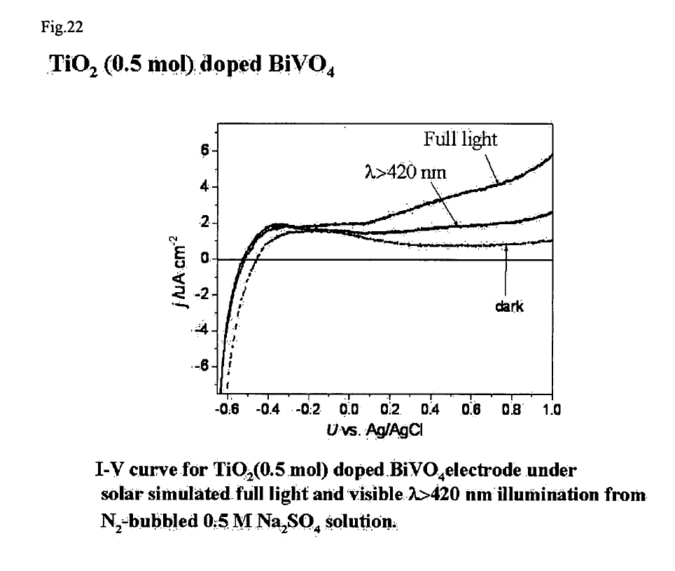

FIG. 17 shows SEM photographs of a photocatalyst BiZn₂VO₆ powder. By comparison between the powder applied with no etching treatment ((a) in FIG. 17) and the powder applied with an etching treatment for 24 hours ((b) in FIG. 17), it is recognized that unevenness of the surface part of the powder applied with an etching treatment has been increased. By thus applying an etching treatment, the particle form and size of the powder are changed, the specific surface area per unit gram is also increased, and activity is improved.

Applying an etching treatment is useful not only for the photocatalyst BiZn₂VO₆ but also for the above-described photocatalyst BiTiVO₆. In the case of the photocatalyst BiTiVO₆, it is preferable to carry out the treatment by use of hydrochloric acid.

### EMBODIMENT 6

In the present embodiment, shown are diffuse reflectance spectra and photocurrent-potential curves of a membrane electrode when two photocatalytic systems of TiO₂ and BiVO₄ are compounded at molar ratios of 1:4 and 1:2 and when compounded at molar ratios of 4:1 and 2:1. It will be understood from these that even when the combination ratio of the two photocatalytic systems of TiO₂ and BiVO₄ is freely changed, this functions as a photocatalyst having a high activity.

### INDUSTRIAL APPLICABILITY

The photocatalyst according to the present invention is excellent in visible light response and can be applied to purification of air and water, antifouling of walls, glass, and the like, sterilization of walls and the like in hospitals, hydrogen evolution by sunlight, and the like. That is, the photocatalyst can be used for outdoor antifouling purposes (for example, paint, exterior materials such as building materials, sound insulating materials, vehicle side mirrors, and the like) by use of sunlight. In addition, the photocatalyst can be used for indoors and car interior antifouling, deodorizing, and antibacterializing purposes (paint, ceramics, glass, interior materials such as building materials, furniture, home appliances, lights, and the like) by use of visible light such as sunlight and fluorescent light.

1. A photocatalyst with visible light response comprising a composite metal oxide, prepared by combination of two photocatalytic systems of TiO₂ and BiVO₄, including elements of Bi, Ti, and V as composition elements.

2. A photocatalyst with visible light response comprising a composite metal oxide, for which two photocatalytic systems of TiO₂ and BiVO₄ are compounded at a molar ratio of 1:9 to 9:1, including elements of Bi, Ti, and V as composition elements.

3. A composite metal oxide for a photocatalyst with visible light response expressed by a general formula BiTiMO₆, wherein M represents at least one element selected from a group consisting of V, Nb, and Ta.

4. A composite metal oxide for a photocatalyst prepared by firing a powder mixture of one selected from NH₄VO₃, Nb₂O₅, and Ta₂O₅ and Bi₂O₃ and TiO₂ under predetermined time and temperature conditions (first firing step), then once cooling, crushing, and again firing the fired product under conditions of the predetermined time and a higher temperature than that of the first firing step (second firing step), and then cooling the fired product.

5. The composite metal oxide for a photocatalyst according to claim 4, wherein the first firing step and the second firing step are carried out in a state where water is placed in a reaction vessel.

6. The composite metal oxide for a photocatalyst according to claim 4, wherein the first firing step is carried out under a temperature condition of 550° C. to 750° C. and the second firing step is carried out under a temperature condition of 800° C. to 900° C.

7. A composite metal oxide for which the composite metal oxide according to claim 3 is further etched in hydrochloric acid or sulfuric acid.

8. A composite metal oxide for which the composite metal oxide according to claim 7 is further crushed by a ball mill.

9. The composite metal oxide according to claim 7 having a function as a photocatalyst.

10. A photocatalyst which is a composite metal oxide, prepared by combination of a metal oxide of ZnO and a photocatalytic system of BiVO₄, including elements of Zn, and V as composition elements.

11. A composite metal oxide for a photocatalyst with visible light response expressed by BiZn₂VO₆.

12. A composite metal oxide for a photocatalyst prepared by firing a powder mixture of a metal oxide of ZnO, Bi₂O₃ and NH₄VO₃ under predetermined time and temperature conditions (first firing step), then once cooling, crushing, and again firing the fired product under conditions of the predetermined time and a higher temperature than that of the first firing step (second firing step), and then cooling the fired product.

13. The composite metal oxide for a photocatalyst according to claim 12, wherein the first firing step and the second firing step are carried out in a state where water is placed in a reaction vessel.

14. The composite metal oxide for a photocatalyst according to claim 12, wherein the first firing step is carried out under a temperature condition of 550° C. to 750° C. and the second firing step is carried out under a temperature condition of 800° C. to 900° C.

15. A composite metal oxide for which the composite metal oxide according to claim 11 is further etched in hydrochloric acid or sulfuric acid.

16. The composite metal oxide according to claim 15 having a function as a photocatalyst.

17. A photocatalyst for which the composite metal oxide according to claim 7 is formed in a microparticle membrane form.

18. A photocatalyst for which the composite metal oxide according to claim 7 is used in a suspension form.

19. A method for producing oxygen and/or hydrogen by photodecomposition of water under irradiation of light including at least visible light by use of the composite metal oxide according to claim 7.

20. A purifying method by photodecomposition of organic matter (such as methanol) under irradiation of light including at least visible light by use of the composite metal oxide according to claim 7.

21. An article provided by coating the composite metal oxide according to claim 7 on a surface of a base material.

22. A visible-light responsive paint including the composite metal oxide according to claim 7 as a material.
